(19) United States
(12) Patent Application Publication
(10) Pub. No.: US 2009/0259486 A1
(43) Pub. Date: Oct. 15, 2009

(54) PATIENT CENTRIC MEDICATION DISPENSING DEVICE

(75) Inventors: Bernard Burg, Menlo Park, CA (US); Kristen Ingalz, San Jose, CA (US); Masaaki Yamashita, Cupertino, CA (US); Shinichi Takarada, San Jose, CA (US)

Correspondence Address: GREGORY A. STOBBS, 5445 CORPORATE DRIVE, SUITE 400, TROY, MI, 48098, US

(73) Assignee: PANASONIC CORPORATION, Osaka (JP)

(21) Appl. No.: 12/415,269

(22) Filed: Mar. 31, 2009

Related U.S. Application Data
(60) Provisional application No. 61/043,496, filed on Apr. 9, 2008.
(60) Provisional application No. 61/043,506, filed on Apr. 9, 2008.
(60) Provisional application No. 61/078,717, filed on Jul. 7, 2008.

(51) Int. Cl. G06Q 50/00; G06F 17/00; G08B 23/00

(52) U.S. Cl. 705/2; 707/104.1; 340/573.1; 700/244; 707/E17.001

(57) ABSTRACT

A patient centric medication dispensing device is herein disclosed. The dispensing device is configured to close the loop between a patient, a treating physician and a pharmacy by monitoring the medication intake of the patient and reporting information to the physician and/or the pharmacy or pharmaceutical company. The dispensing device is further configured to calculate adverse drug effects that may result if a patient takes a requested medication, based on medication that has already been dispensed and medication that is scheduled to be taken. The dispensing device is also configured to provide the patient with educational information based on the situation the patient has encountered, such as missing a scheduled dosage or suffering from side-effects.

### CROSS-REFERENCE TO RELATED APPLICATIONS

This application claims the benefit of U.S. Provisional Application Nos. 61/043,496, 61/043,506, and 61/078,717 filed on Apr. 9, 2008, Apr. 9, 2008 and Jul. 7, 2008, respectively. The entire disclosure of each of the above applications is incorporated herein by reference.

### FIELD

The present disclosure relates to a patient-centric medication dispensing system.

### BACKGROUND

It is currently estimated that only 50% of prescribed medications are actually taken by patients. Additionally, many patients do not complete a prescription through the therapy period. These deviations from therapy lead to approximately 225 million hazardous situations each year. Moreover, an average of 2.3 serious medication errors occur each month, primarily affecting elderly patients. Thus, there is a need for a device that will help ensure that prescribed therapies are adhered to by patients.

Beyond deviations from prescribed therapies, roughly 20% of prescriptions are never filled. Of those prescriptions that are filled, it is estimated that up to 60% of prescriptions are incorrectly taken or not taken at all. These problems may be primarily observed in older patients. Deviation from prescribed therapy may include simply not filling the prescription, overmedication, forgetting to take scheduled doses, deliberate under-dosing, accidentally taking the wrong medication, taking the correct medication at incorrect times, taking someone else's medication, taking dangerous combinations of medication, and hoarding medications for later consumption. It is posited that nearly 90% of elderly patients deviate from prescribed therapies in one way or another, and 35% make potentially serious errors.

In the setting of a hospital, it is easier to monitor the treatment of patients. As most patients are treated outside of hospitals, however, it is difficult for healthcare providers to ensure that elderly patients are adhering to the prescribed regimen. In fact, studies suggest that an estimated 225,000 lives may be saved annually if patients better complied with prescribed medications. Additionally, medication errors, such as those described above, are estimated to cost society billions of dollars annually. With respect to elderly patients, noncompliance with medicine regimens is responsible for nearly 25% of nursing home admissions. Thus, it can be appreciated that noncompliance with prescribed therapies is a great cost to quality of life and society. As the costs of health care and nursing care increase, as national resources for programs such as Medicare dwindle, and as the baby-boomer generation reaches its silver years, a strong felt need for a device which helps ensure safe and complete adherence to prescribed treatments is realized.

Furthermore, even when patients do adhere to regularly scheduled prescriptions, improper combinations of medications may create dangerous conditions. The average 70 year-old patient is prescribed, on average, 15 medications. Of those, some are taken at regularly scheduled periods, while other medications are taken optionally to treat symptomatic conditions as they occur. This does not even take into account over-the-counter medications that a patient may take. Making matters worse, the treating physician may have no knowledge of the over-the-counter medications that are purchased after the prescriptions are written by the physician. Such scenarios are leading causes of adverse drug effects (ADE). A patient, in taking his or her regularly prescribed medication, may take an optional drug, either prescription strength or over-the-counter, which results in an adverse reaction. Such ADEs may result from the accumulation of certain compounds in access of safe levels or from toxic combinations of normally safe pharmacological compounds. While a pharmacologist may be able to predict such ADEs, elderly patients with diminishing capacities cannot become experts in the medications they are taking and will often forgo reading the medication instructions. Thus, there is a need for an accessible device that may warn patients or caring physicians of situations that may result in ADEs. Furthermore, there is a need for a device that can help patients administer optional medications at safe time periods.

This section provides background information related to the present disclosure which is not necessarily prior art.

### SUMMARY

This section provides a general summary of the disclosure, and is not a comprehensive disclosure of its full scope or all of its features.

In a first sense, a patient centric electronic medication dispensing device is disclosed. The dispensing device comprising a prescription download module that receives a prescription of a patient and prescription information from a pharmacy, wherein the prescription includes a medication of the patient and instructions for administering the medication. The dispensing device further comprising a prescription management module that generates a treatment regimen for the patient based on the prescription and the prescription information, and that sends a notification to a server associated with the physician when the patient deviates from the treatment regimen.

In a second sense, a patient centric medication dispensing device comprising a datastore storing a schedule for a patient to administer regularly scheduled medication and an optional medication module that receives a request from a patient for an optional medication to be dispensed by the dispensing device is disclosed. The dispensing device further comprises an adverse drug effect module that calculates a cumulative level of at least one active compound found in the requested optional medication, wherein the cumulative level represents an amount of the at least one active compound in the patients body that would result if the patient administered the optional medication and the regularly scheduled medication, and that generates an alert when the cumulative level exceeds a predetermined threshold.

In a third sense, a patient centric medication dispensing device comprising a datastore storing a schedule for a patient to administer medication of the patient and a drug database storing educational information corresponding to the medication of the patient is disclosed. The dispensing device further comprises a dispensing module that dispenses medication to the patient based on a request of the patient and the schedule for a patient to administer the medication. The dispensing device includes a prescription management module that monitors the patient's compliance to the schedule and that notifies the patient when the patient deviates from the schedule. Furthermore, the device includes an education module that retrieves the educational information from the drug database when the patient deviates from the schedule and communicates said educational information to the patient, wherein the educational information includes instruction for the patient to follow when the patient deviates from the schedule.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram illustrating an exemplary embodiment of the dispensing device;

FIG. 2 is a diagram illustrating exemplary screen shots of different operational modes;

FIG. 3 is a diagram illustrating an exemplary dispensing device in a cradle;

FIG. 4 is a functional block diagram of the dispensing device;

FIG. 5 is a diagram of an exemplary medical regimen table;

FIG. 6 is a diagram of an exemplary method for downloading a prescription;

FIGS. 7A and 7B are diagrams of exemplary methods for managing a patient's prescription;

FIGS. 8A and 8B are diagrams of exemplary methods for refilling the dispensing device;

FIG. 9 is a screen shot of an exemplary user interface for assisting a patient refilling the dispensing device;

FIG. 10 is a diagram of an exemplary method for dispensing medication;

FIG. 11 is a diagram of an exemplary method for suggesting an optional medication to a patient;

FIGS. 12A-12C are screen shots of user interfaces for assisting a patient in selecting an optional medication;

FIG. 13 is a diagram of an exemplary method for calculating an adverse drug effect;

FIGS. 14A-14C are graphs displaying various compound levels represented as functions of time;

FIG. 15 is a diagram illustrating an exemplary patient's compliance to a medical regiment; and

FIG. 16 is a diagram illustrating an exemplary supply chain model using the dispensing device; and

FIG. 17 is a diagram illustrating an alternative embodiment of the medication dispensing device.

Corresponding reference numerals indicate corresponding parts throughout the several views of the drawings.

### DETAILED DESCRIPTION

Example embodiments will now be described more fully with reference to the accompanying drawings.

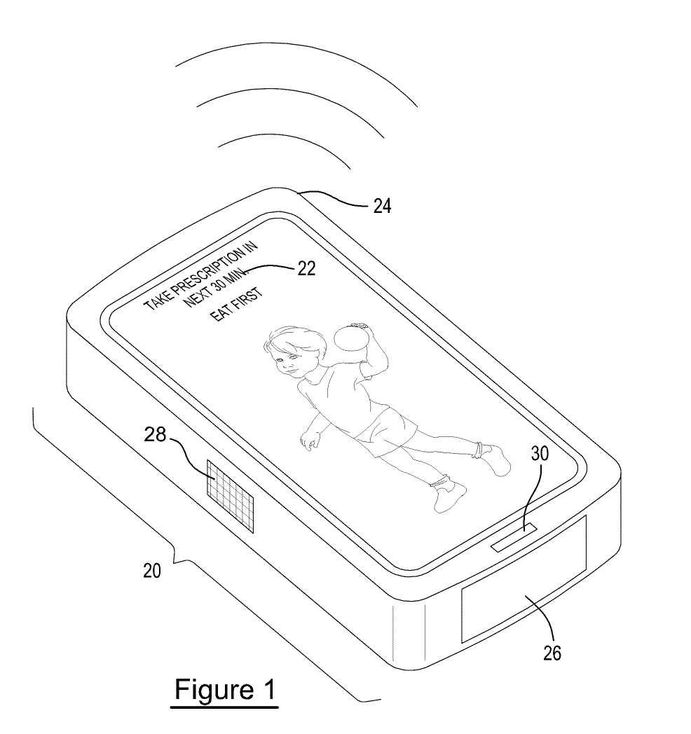

FIG. 1 depicts an exemplary embodiment of an electronic medicine dispensing device 20. The exemplary dispensing device 20 can include a screen 22 displaying a user interface, a transceiver 24, and a dispensing door 26 for dispensing the medication. Internally, the dispensing device 20 can include receptacles for holding the medications (not shown), a processing unit (not shown), an electronic memory (not shown), the transceiver 24, and an interface to connect to a cradle or docking station (not shown). Additionally, the dispensing device 20 may include a speaker 28 and/or a microphone 30.

Due to the fact that the dispensing device 20 may include a processor, memory, a transceiver 24, and a screen, it should be appreciated that the dispensing device 20 may function as an audio/visual player, a PDA, a telephone, or a portable web browser. As such, the dispensing device 20 may operate in two modes, as a dispensing device and as a media device. Unless otherwise noted, any reference to the dispensing device 20 refers to the device operating as a dispensing device 20.

The screen 22 provides a means for communicating with the patient. The screen 22 may be a touch screen, an LCD, an OLED screen, or any other type of screen known in the art. Preferably, a touch screen 22 is used so that the user can easily interact with dispensing device 20. Screen 22 displays the user interface to the user. The user interface may allow a patient to request that medications be dispensed, to receive notifications of medications that need to be taken, to receive warnings of possible adverse drug effects, to receive notifications when a prescription is getting low, to receive educational materials relating to the prescribed medicines. Additionally, the screen 20 may be an interface for the media capabilities when the device is operating as a media device. Depending on the enabled media capabilities, an appropriate resolution for the screen should be chosen.

The transceiver 24 is used to enable communication with a network so that information relating to the patient's prescriptions may be communicated to and from the dispensing device 20. Details of the types of communications that are transmitted by the transceiver are described in further detail below. The transceiver 24 may be a WiFi enabled receiver, a bluetooth receiver, an IR receiver, or any other type of receiver that may be used to communicate over a network either directly or through an intermediate device such as a computer. Optionally, the dispensing device 20 itself may be configured without a transceiver if the cradle or docking station or another device that interfaces with the dispensing device 20 is able to connect to a network.

The device may also have a number of audio/visual media enabling features, such as a speaker 28 or a microphone 30. The type of media that is enabled, e.g. audio, video, communications, should determine what types of audio/visual features should be added. For example, if the dispensing device 20 is enabled as a mobile telephone, then a speaker and a microphone are likely required. If the device is an audio player or a audio/video player, then a speaker may be required but a microphone 30 may be unnecessary. Furthermore, although not shown, a jack for a headphone set may also be featured on the dispensing device 20.

The dispensing door 26 opens when a pill is to be dispensed. The dispensing door 26 is controlled by the dispensing module, described in greater detail below. When a user instructs the dispending device 20 to dispense medication, the specified medication will be retrieved from the receptacle containing the medication and delivered to the user via the dispensing door 26. It should be appreciated that the dispensing door 26 may take a variety of forms. For example, the door may slide open, hinge open, or retract.

The dispensing device 20 may also include a refilling door (not shown). The refilling door provides a means to fill the medication pills into the device. If the refilling process is wholly automated, then the refilling door will only open when the dispensing device 20 is in the cradle. If, however, the refilling process includes manually inserting the pills, the refilling door will open upon a user command or the user manually opening the refilling door.

Internally, the dispensing device 20 contains receptacles for storing the different types of medication. It should be appreciated that any receptacle designed to automatically dispense a selected medication may be used.

Internally, the dispensing device 20 has a processor and a memory. It is envisioned that various types of memory may be used. For example, the dispensing device 20 may include RAM and a hard disk. The dispensing device 20 may also include flash memory or other types of non-volatile memory instead of a hard disk.

The dispensing device 20 includes a power source. The preferred power source is a rechargeable battery, such as a lithium ion battery. It is envisioned, however, that the dispensing device 20 may be operated with disposable batteries or even connected to an AC or DC power supply.

The dispensing device 20 may also include ports to connect to a computer. The ports may include, but are not limited to, a USB port, a FireWire port, or an Ethernet port.

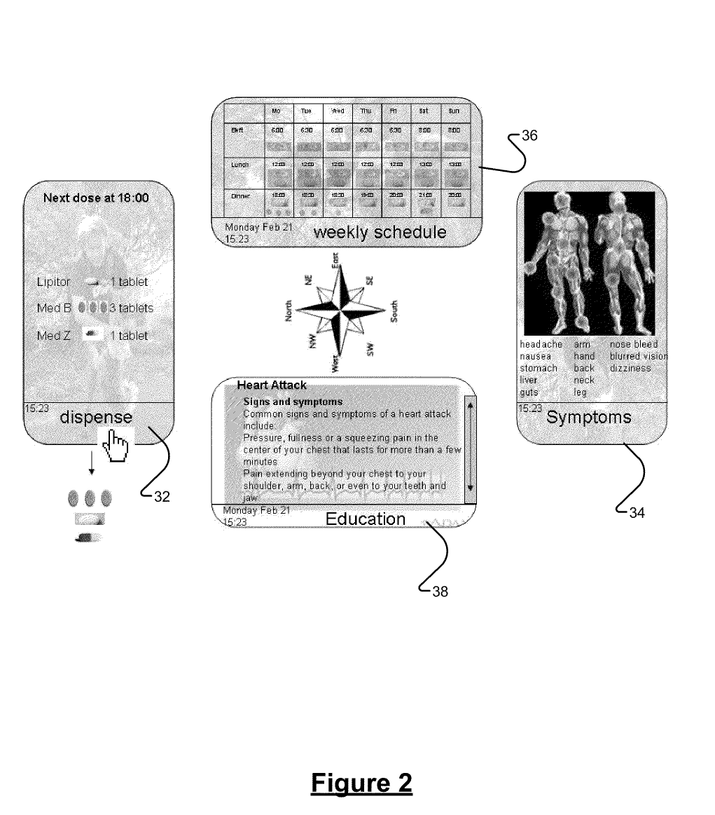

The dispensing device 20 may also include an accelerometer. The accelerometer may be used to determine the orientation of the dispensing device 20. For explanatory purposes, the orientations are referred to as North, South, East and West. When the device is rotated 90° about the axis going through the center of the screen 22, the orientation changes. Each orientation may be mapped to a separate orientation mode. FIG. 2 provides an example of the different types of orientation modes. The North position 32 corresponds to the dispensing door oriented downwardly. In the North position 32, the dispensing device 20 may operate in dispensing mode. In dispensing mode, the dispensing device 20 can deliver a medication pill upon a patient's request. The South position 34 may correspond to the device door 26 being oriented upwardly. In the South position 34, the dispensing device 20 may show potential symptoms of that the patient might endure. If a touch screen is enabled, the patient may zoom in on specific body parts or to select a description of the symptom. Based on the patient's selection, the dispensing device 20 may provide suggestions of optional medications. In the East position 36, the dispensing device 20 may operate to display a schedule for the patient's treatment regimen. In the West position 38, the dispensing device 20 may operate in an education mode, whereby the patient may receive informational material relating to selected pharmaceutical products. The details of these orientation modes will become more apparent below.

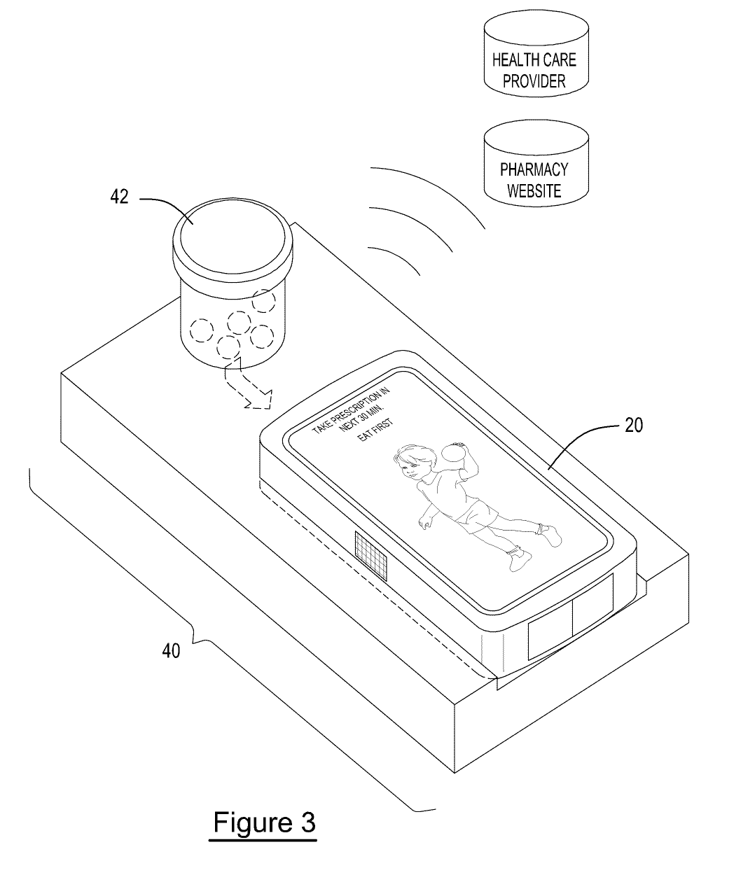

FIG. 3 depicts the dispensing device 20 in a cradle 40. The cradle 40 may include an interface to connect to the dispensing device 20, a mechanism to fill the dispensing device 20, a port to receive a cartridge containing medication pills, and a communication port to communicate with a computer or other devices.

The cradle 40 is one way to upload prescription information to the dispensing device 20. Moreover, the cradle 40 may be used to refill medication into the dispensing device 20. Thus, the cradle should have an interface that allows the cradle 40 and the dispensing device 20 to communicate with one another. Furthermore, the interface may also be used to charge the device. It is envisioned that the cradle/dispensing device interface may be similar to docking station interfaces that interface a portable device to a docking station.

The cradle 40 may also have a port to receive a cartridge containing medication pills. As discussed, the cradle 40 may be used to automatically fill the dispensing device 20. One such way is to insert a cartridge containing the medication to be filled into the dispensing device 20. The cradle 40 reads the prescription and prescription information from the prescription cartridge, including the type and amount of pills contained in the cartridge. The dispensing device 20 then selects the target receptacle for the specific medication and opens the refilling door. The cradle 40 then opens a door on the cradle side which allows the pills to be refilled into the dispensing device 20 from the cartridge. Greater details of refilling the dispensing device 20 are provided below.

The foregoing description described physical elements contained in one embodiment of the dispensing device 20. It should be appreciated that alternative embodiments for the dispensing device 20 exist. The following section describes the functionality of the dispensing device 20 as well as descriptions of the modules enabling said functionality.

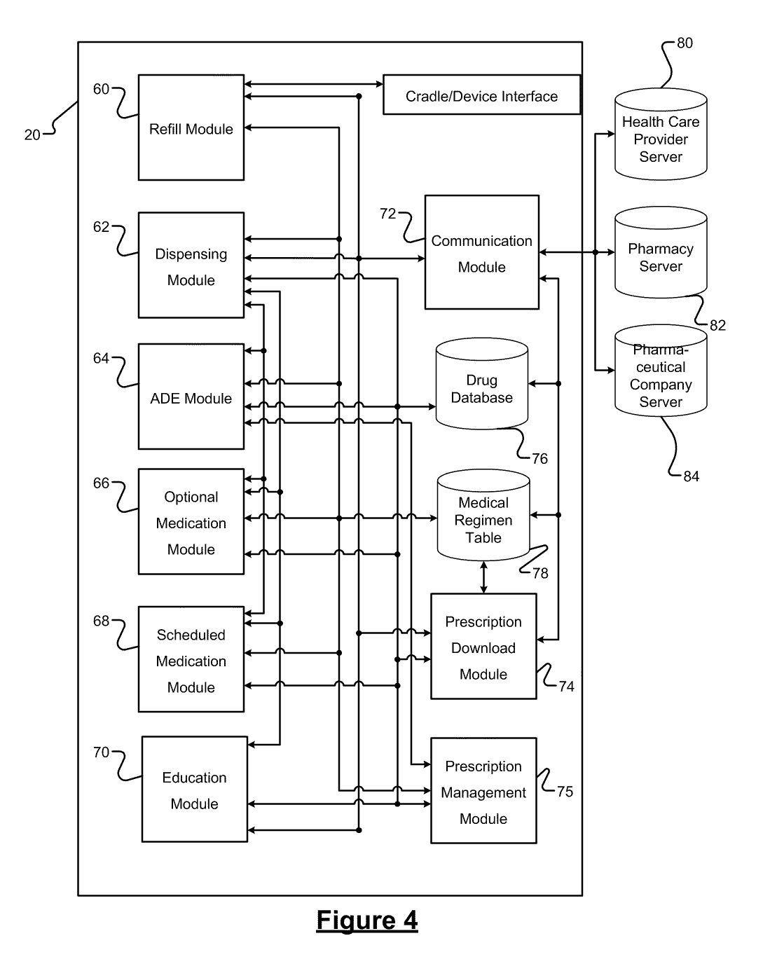

FIG. 4 provides an exemplary embodiment of the modules and databases for enabling the functionalities of dispensing device 20. Dispensing device 20 may include a refill module 60, a dispensing module 62, an adverse drug effect (ADE) module 64, an optional medication module 66, a scheduled medication module 68, an education module 70, a communication module 72, a prescription download module 74, a prescription management module 75, a drug database 76, and a medical regimen table 78. It is envisioned that communication may be enabled from the dispensing device 20 to one or more of a health care provider server 80, a pharmacy server 82, and one or more pharmaceutical company servers 84.

Exemplary prescription download module 74 may receive a prescription and prescription information via communication module 72 and fills or updates medical regimen table 78. Prescription download module 74 may also receive the prescription and prescription information via the cradle, when the prescription is being refilled. The prescription is the actual prescription written by a physician or health care provider. In addition, the prescription may be sent to the user device via a communications network or may accompany the actual medication in an electronic form contained on the cartridge. The prescription may contain the name of the medication, the amount of medication, the physicians instructions, e.g. “take twice daily with food,” the name of the prescribing physician, the date of the prescription, the expiration date of the prescription, and the refill instructions. Furthermore, the prescription download module 84 may receive, via the communication module 72 or the cradle 40, prescription information. Prescription information is additional information relating to the medication. Prescription information may include pharmacokinetic data, educational data, ADE data, and a date corresponding to when the prescription is dispensed.

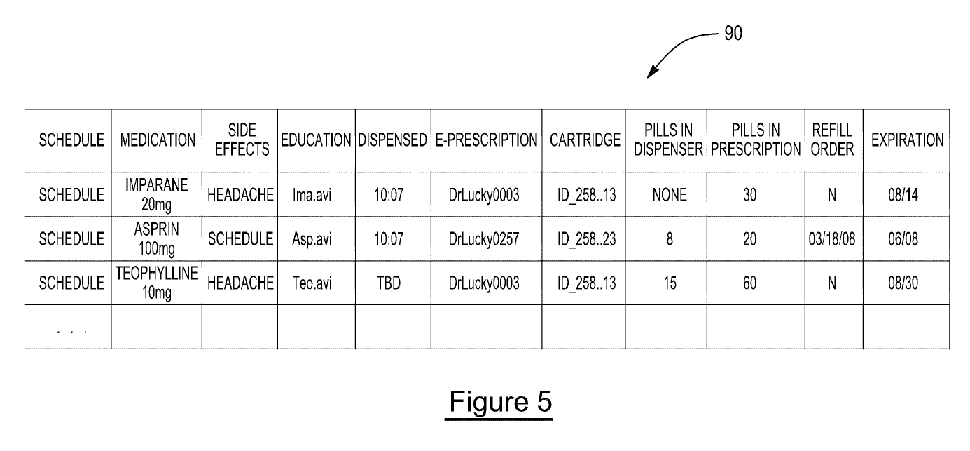

Prescription download module 74 receives the prescription and the prescription information and populates the medical regimen table 78. An exemplary medical regimen table 90 is depicted in FIG. 5. The medical regimen table 90 may include fields for the medication, the schedule for administering the medication, possible side effects, a pointer or link to the educational data, the time of the last dispensed dose, the prescription, the cartridge id, the refill instructions, an expiration date, ADE information, the amount of pills remaining in the prescription and the amount of pills remaining in the dispensing device 20.

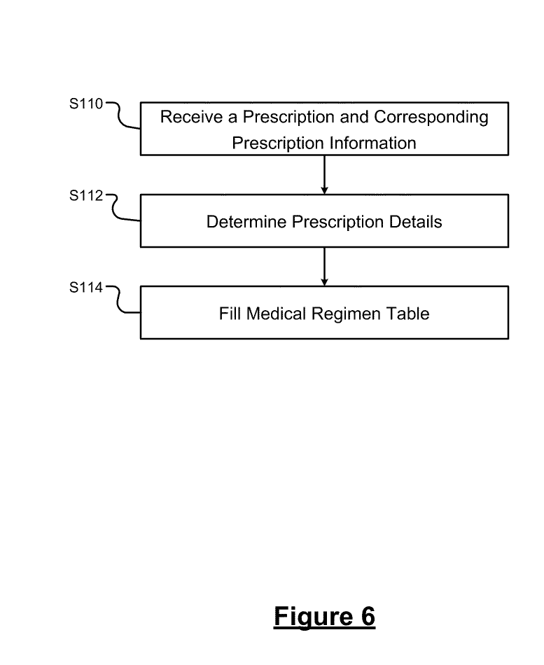

FIG. 6 depicts the exemplary logic performed by prescription download module 74. At step S110, prescription download module 74 receives a prescription and corresponding prescription information. As mentioned, said prescription and prescription information may be received directly from the physician or the pharmacy via a wireless communication network. Additional information such as the educational information and the ADE information may be received from the pharmaceutical company. The prescription and prescription information may also be received via the cradle/device interface, when the dispensing device 20 is in the cradle 40.

At step S112, prescription download module 74 determines the prescription details. Prescription download module 74 may first determine the prescription, e.g. the medication, instructions for administration of the medication, the prescribing doctor, the expiration date, the amount of pills, etc. Furthermore, prescription information may also be unpacked from the received message. A data structure may be created that stores the prescription and the prescription information. The created data structure may be accessed at step S114 to populate or update the medical regimen table 78.

At step S114, prescription download module 74 fills/updates the medical regimen table 78. It should be appreciated that populating the data structure, described above may actually be filling the table. Alternatively, entries in the data structure may be read into a separate table, similar to the table shown in FIG. 4. It is envisioned that other methods for downloading the prescription to the dispensing device may be performed by prescription download module 74.

Prescription management module 75 may monitor the medical regimen table 78 and perform various actions based on the contents of medical regimen table 78. Prescription management module 75 may monitor the amount of pills remaining in a prescription, the amount of pills in the device, and the adherence of a patient to a schedule for taking medication.

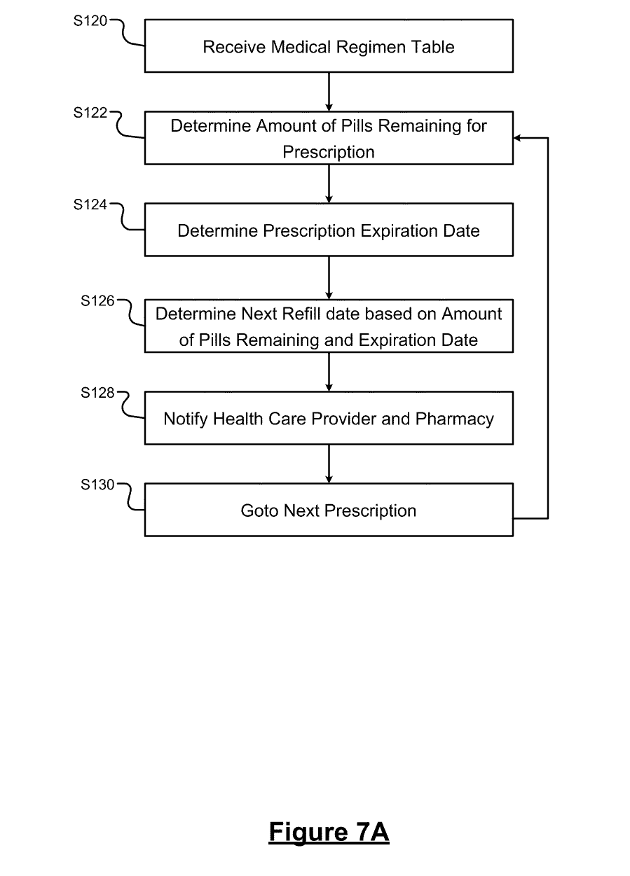

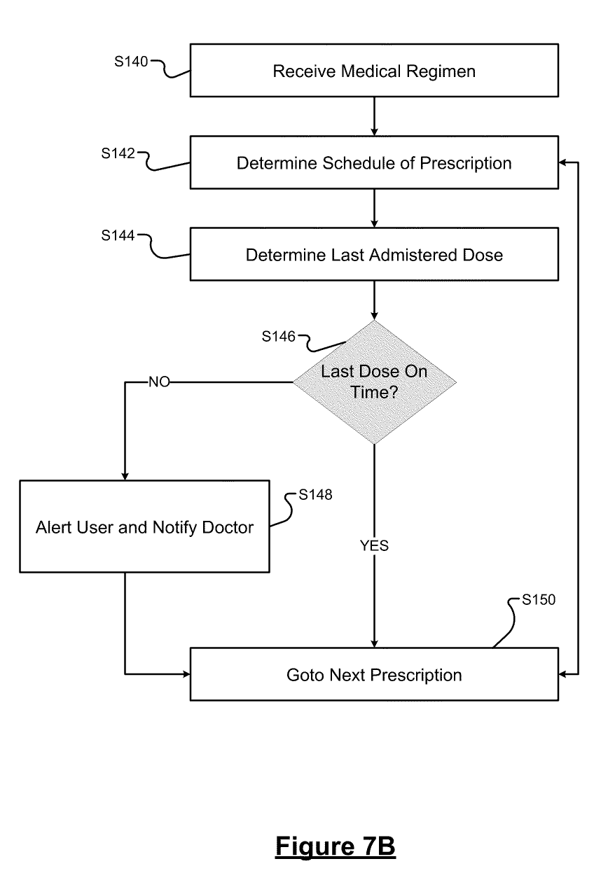

FIG. 7A depicts exemplary logic carried out by prescription management module 75 when monitoring the amount of pills remaining in a prescription. The following routine may run at predetermined times, or may be initiated upon the occurrence of a condition, such as refilling or dispensing a pill. At step S120 the medical regimen table 78 is received, e.g. read from memory. Prescription management module 75 may then analyze each row of medical regimen table 78 at steps S122-S126. At step S122, the amount of pills remaining in the prescription is read from the table. At step S124, the expiration date is read from the table. Based on the remaining days left in the prescription or the amount of pills remaining in the prescription, the prescription management module may determine that the prescription needs to be refilled at S126. For example, the prescription may not expire for three weeks, but the patient may be out of pills. In this instance prescription management module 75 may determine that the prescription needs to be refilled. If, however, the prescription is out of refills, then prescription management module 75 may determine that the prescription cannot be refilled. At step S128, prescription management module 75 may notify the physician and/or the patient's pharmacy that a prescription requires refilling. Alternatively, prescription management may notify the physician that the prescription has not been finished by the patient, despite the fact that the expiration date has passed. This type of action will help a physician determine whether a patient is adhering to the treatment regimen. At step S130, prescription management goes to the next row in the table and repeats steps S122-S128. It is envisioned that prescription management module 75 may be implemented with alternative methods for determining the status of the prescription.

Prescription management module 75 may also determine a schedule for administering the medication. Prescription management module 75 may retrieve the medical regimen table 78. For each prescription that is to be taken on a regular schedule, the prescription management module 75 may determine a schedule based on the amount of times a patient is to take the medicine. Prescription management module 75 may base the calculations on a 16 hour day, unless the prescription instructions call for the medication to be taken in the middle of the night as well. Furthermore, the patient may enter approximate waking and sleeping times, so that the schedule may be further customized. Additionally, prescription management module 75 may interface with the ADE module to determine if an alternate schedule must be created to accommodate two medications that may adversely react with one another. The generated schedule may also be stored in the medical regimen table 78.

Prescription management module 75 may also monitor the patient's administration of his or her medication. FIG. 7B depicts exemplary logic performed by prescription management module 75 for monitoring a patient's administration of his or her medication. At step S140, prescription management module 75 reads the medical regimen table 78. As mentioned, prescription management module 75 may generate a schedule for a patient taking his or her medication. Also, the medical regimen table 78 may also keep track of the last administered dose of a medication. At step S142, prescription management module 75 determines when the last dose should have been administered according to the schedule for the prescription. At step S144, prescription management module 75 determines when the last time a dose was actually administered from medical regimen table 78. It should be noted that when dispensing module 62 dispenses a pill, the dispensing device 20 assumes that the dose was actually taken by the patient. At step S146, prescription management module 75 determines if the patient took the previously scheduled dose. It the patient did not take the last scheduled dose, prescription management module 75 may notify the user, via the user interface, that the dose needs to be taken and may notify the treating physician, via the communication module 72, that the patient may have missed regularly scheduled dose. This information need not be directly communicated to the physician but may be communicated to the health care provider server 80. It should be appreciated that other methods for determining if a patient adhered to the schedule may be implemented by prescription management module 75. Furthermore, it is envisioned that prescription management module 75 may monitor the patient's adherence to the other aspects of the treatment regimen, in addition to the schedule. For example, the prescription management module 75 may monitor if the patient is over-medicating or under medicating.

Refill module 60 may be used to update the medical regimen table 78 when the dispensing device 20 is filled/refilled with the prescription medication. As discussed, dispensing device 20 may be loaded with the medication automatically or manually. In either scenario, the dispensing device 20 should be entered into a refill mode. Once in refill mode, refill module 60 may be activated or called by dispensing device 20. Depending on whether the dispensing device 20 is automatically filled or must be manually filled, the method for filling the prescription will differ.

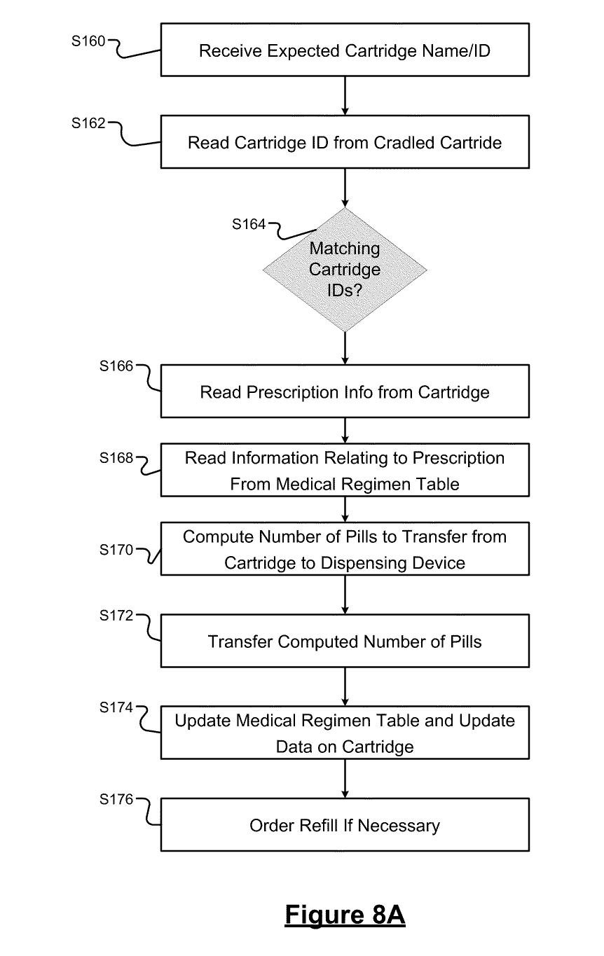

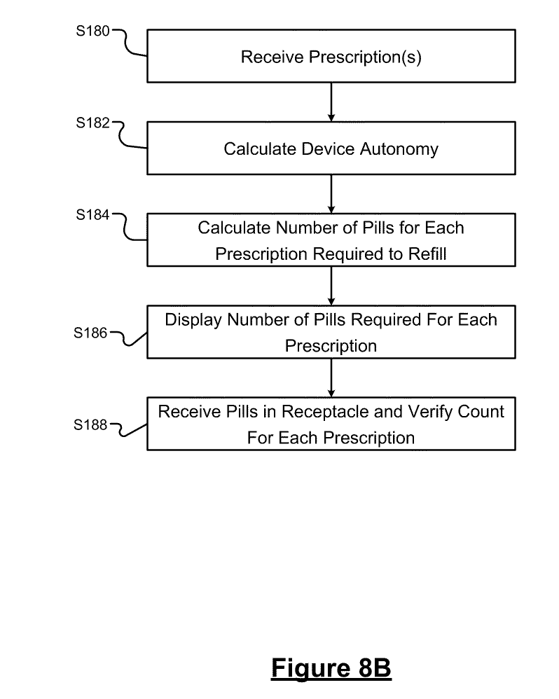

FIG. 8A depicts an exemplary method for automatically filling the dispensing device 20 using a cradle. It is envisioned one way of delivering a prescription to a patient is to send sealed cartridges containing a weekly or monthly supply of one or more prescriptions. The cartridge may also include a small memory chip containing prescription information. At step S160 the user enters the name of the cartridge or a cartridge ID that is to be loaded. At step S162, refill module 60 reads the cartridge id from the cartridge. If the cartridge ID matches the entered cartridge ID or corresponding cartridge name, then refill module proceeds to step S166. At step S166, prescription information may be read from the cartridge. As discussed, the prescription information may include pharmacokinetic data, educational data, ADE data, and when the prescription was dispensed by the pharmacy. Additionally, the prescription itself may be read from the cartridge. At step S168, refill module 60 may read relevant fields from the medical regimen table 78, including the schedule, instructions from the physician, and the number of pills remaining in dispensing device 20. Based on the information in medical regimen table 78, refill module 60 determines the number of pills to transfer from the cartridge to the dispensing device 20. The cradle then transfers the appropriate number of pills from the cartridge to dispensing device 20 at step S172. It should be appreciated that each type of medication should be placed into the corresponding receptacle. At step S174, the medical regimen table 78 may be updated. Namely, the number of pills in the dispensing device 20 should be updated to reflect the newly added pills. At step S176, a notification may be sent to the pharmacy if the cartridge is completely or nearly empty. If there are pills remaining in the cartridge, the cradle may reseal the cartridge.

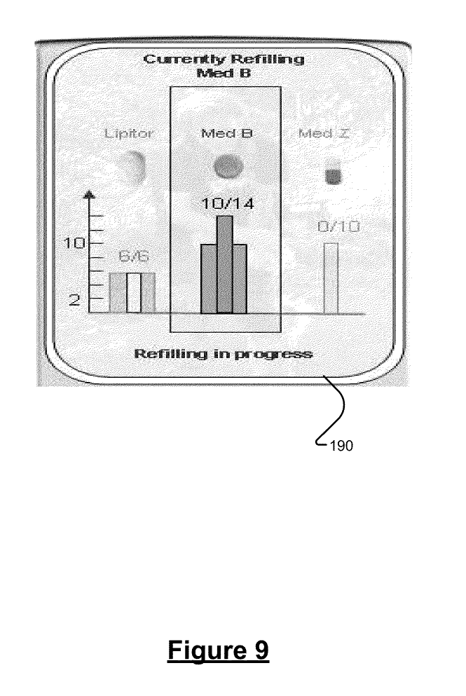

FIG. 8B illustrates an exemplary method for manual refill of the dispensing device. When the dispensing device is filled manually, the device may receive the prescription at step S180. At step S182, the refill module 60 will calculate the device autonomy. The device autonomy is the amount of days the device may be away from the stash of medication without requiring a refill. The device may look to the medical regimen table 78 to determine the schedule and how many pills are currently in each receptacle. Based on this, refill module 60 will determine how many pills are required for each prescription to achieve the desired autonomy. At step S184, the refill module 60 displays on the user interface how many pills from each prescription need to be manually inserted into the dispensing device 20. The user then may select which type of medication will be filled next, and then the user refills the selected prescription manually by inserting the required number of pills into the dispensing device 20. As the user inserts pills, refill module 60 updates the count and may display the count on the user interface. FIG. 9 depicts an exemplary user interface displaying the amount of pills needing to be filled. As can be seen, the receptacle for Lipitor® is filled completely with 6 pills, the receptacle for Medication B is filled with 10 of 14 pills, and the receptacle for Medication Z needs is yet to be filled. Once the user finishes filling the prescription, refill module 60 checks the prescription and the medical regimen table 78 in order to ensure that the patient properly filled the device. It is envisioned that other methods of refilling the dispensing device 20, either manually or automatically, may be utilized by refilling module 60.

The logic to dispense pills is performed by dispensing module 62. Dispensing module 62 may receive requests to dispense pills and update the medical regimen table 78 upon dispensing a pill. Dispensing module may receive a request to dispense pills from scheduled medication module 68 or optional medication module 66. Dispensing module 62 may communicate with ADE module 64 and education module 70 prior to dispensing the requested pill. For example, a patient who takes Medicine A on a regular schedule may request dispensing of optional Medicine B at the same time as Medicine A. Dispensing module 62 would communicate the selected combination to ADE module 64. ADE module, described in greater detail below, would determine the possibility of any adverse effects from taking the medications in combination. Dispensing module 62 may communicate the results to the patient via the user interface. Again, for example, dispensing module 62 may receive a request to dispense three extra-strength pain killers. Dispensing device 20 may communicate the request to education module 70, described in greater detail below. Education module 70 may determine that such a dosage could cause serious injury. Dispensing device 20 would then communicate such educational information to the patient via the user interface.

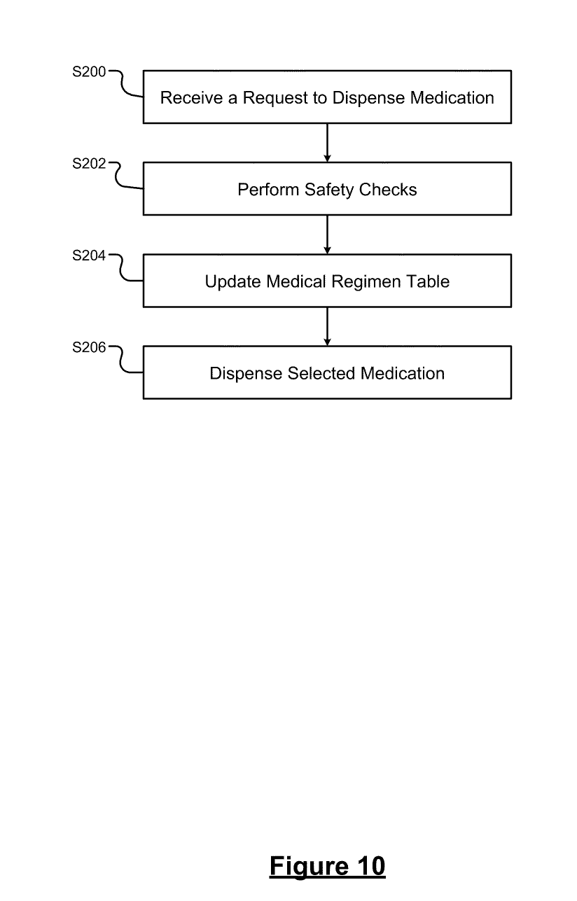

FIG. 10 provides an exemplary method for dispensing medication. At step S200, dispensing module 62 receives a request to dispense medication, either optional or scheduled. At step S202, dispensing module 62 may perform safety checks, such as communicating with ADE module 64, education module 70, or checking the expiration date of the prescription from the medical regimen table 78. If a possible safety hazard exists, dispensing module 62 may alert the user via the user interface. In certain scenarios, dispensing module 62 may preclude the dispensing device 20 from dispensing the dangerous combination. At step S204, dispensing module 62 updates the medical regimen table 78. Updating the medical regimen table 78 may include updating the row corresponding to the selected prescription. The fields that may be updated include the field indicating the last administered dose, the amount of pills remaining in the device, and the amount of pills remaining in the prescription. Furthermore, if the dosage was taken off schedule, the dispensing device 20 may communicate the current time to prescription management module 75, so that the schedule may be recalculated based on the last administered dose. Also, dispensing device 20 may communicate statistics relating to the administration to the primary healthcare provider server 80. At step S206, dispensing module 62 directs the dispensing device 20 to release the requested pill from a particular receptacle. Other methods for dispensing medication may also be performed by dispensing module 62.

Scheduled medication module 68 monitors the scheduled prescriptions for the patient and manages the distribution of the scheduled medication. As discussed, medical regimen table 78 may store a schedule for treatment. Scheduled medication module 68 may receive the schedule from the medical regimen table 78 and display it on the screen 22 via the user interface. Scheduled medication module 68 may further receive instructions from the patient to dispense a pill via the user interface. Scheduled medication module 68 may send a request to dispensing module 62 to dispense the scheduled pill. Prior to dispensing the medication, scheduled medication module 68 verifies that the request falls within a window around the regularly scheduled dose. If the request falls within the window, then the request is processed by scheduled medication module 68 and sent to dispensing module 62. If the request does not fall within the window, scheduled medication module may perform at least one of: alerting the patient that the dose is not scheduled and asking the patient if they would like to proceed with the dispensing anyway; sending a request to education module 70 to inquire about the effect of taking the medicine off schedule and possibly displaying the results to the patient; sending a request to ADE module 64 to determine if any adverse interactions with other scheduled drugs may occur if the medicine is taken off schedule and communicate the results to the patient via the user interface and to the treating physician via the communication module 72.

Optional medication module 66 manages the distribution of the optional medications. Optional medications may include prescription medications that are not regularly taken, e.g. extra strength pain killer medication, anti-inflammatory medication, or motion sickness medication. Optional medications also may include over the counter drugs, e.g. Aspirin®, Claritin®, or Tylenol®. Optional medication module 66 may display to the patient, via the user interface, a list of optional medications in the dispensing device 20, whereby the patient may select an optional medication from the list to be dispensed. In an alternative embodiment, optional medication module 66 may display a human body, whereby a patient can select a body part or region to drill down. Once drilled down, the patient may select a symptom from a list of symptoms. Based on the selected symptom, optional medication module 66 will suggest a medication to the patient.

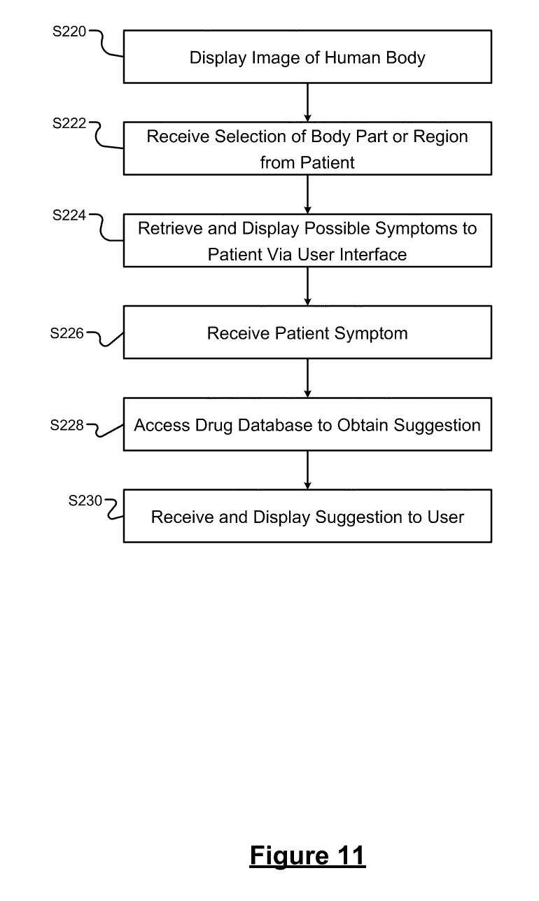

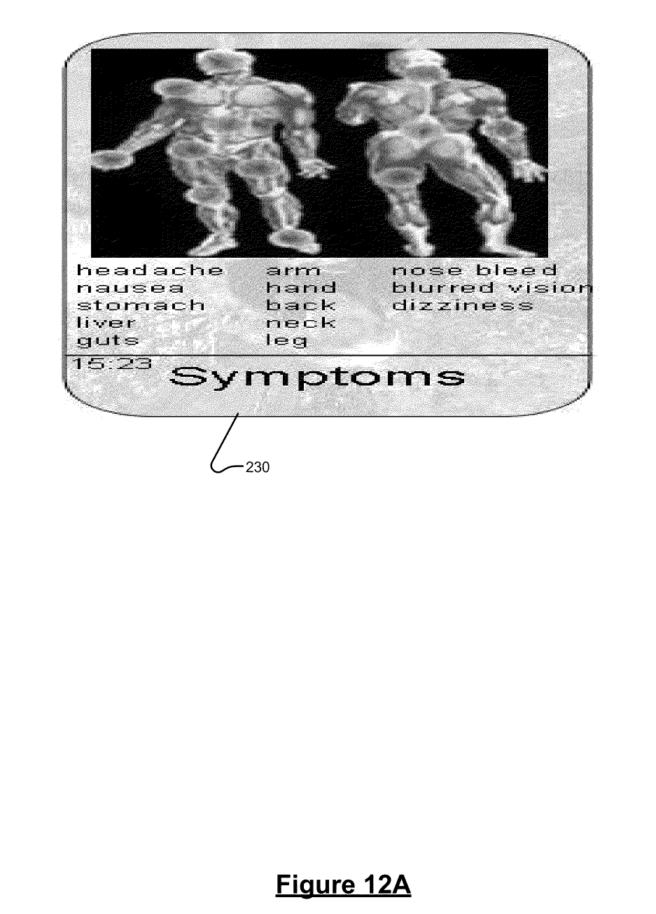

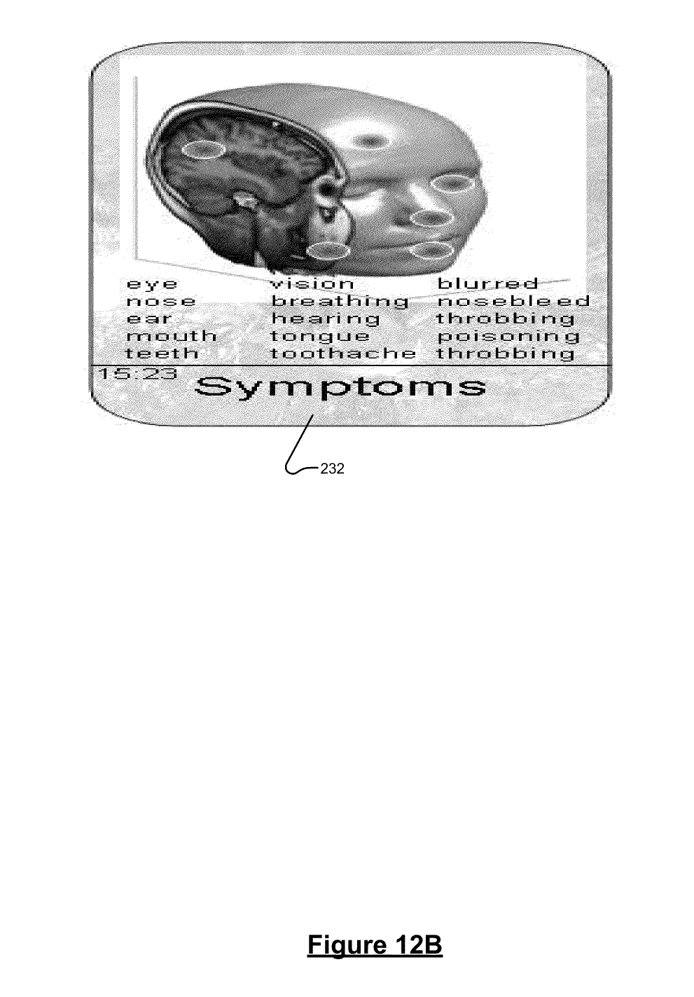

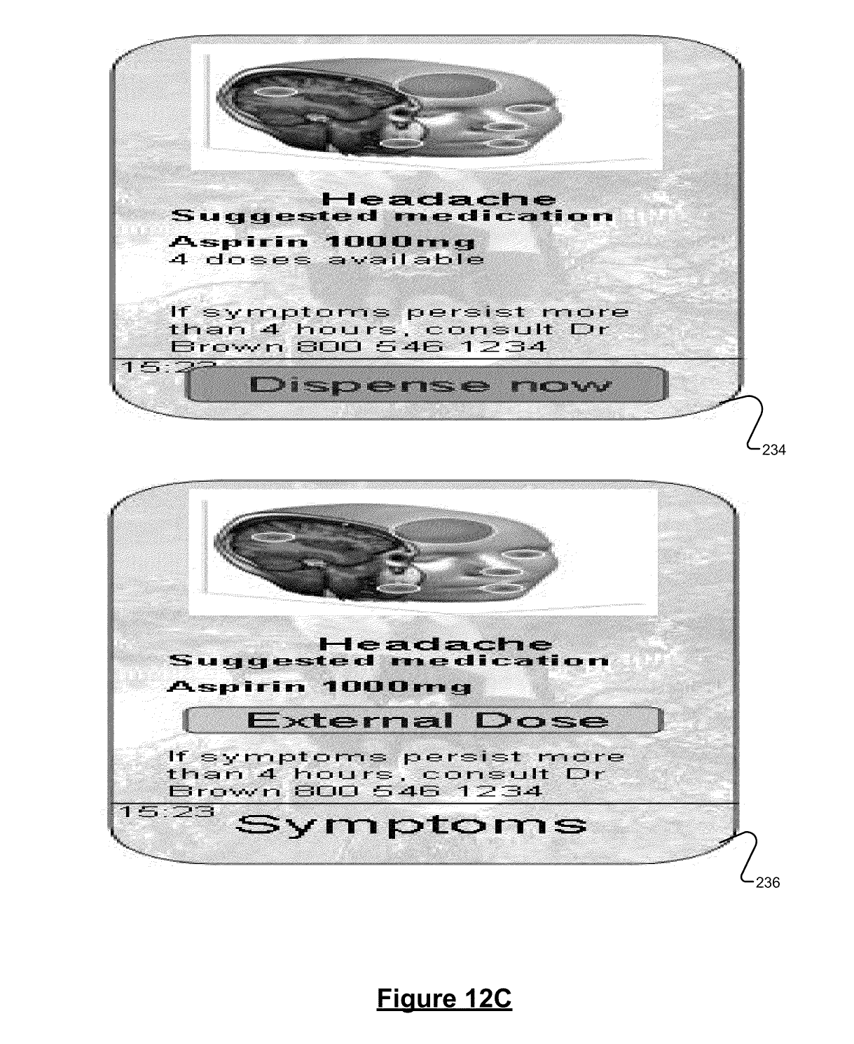

FIG. 11 is a flow diagram illustrating the exemplary logic performed by optional medication module 66. At step S220, optional medication module 66 may display an image of the human body. FIG. 12A depicts an exemplary image that may be displayed on the screen by optional medication module. At step S222, the patient may select a body part or a region of the body. If the screen 22 of the dispensing device 20 is a touch screen, the patient may select a body part or region by touching the screen 22. After the patient selects a body part, optional medication module 66 may retrieve a list of symptoms specific to the selected body part or region and a corresponding image and may display the retrieved symptoms specific to specific body parts and the corresponding image on the screen at step S224. FIG. 12B illustrates an exemplary screen shot of a selected body part, i.e. a head, and a list of symptoms. At step S226, the patient selects a symptom, via the user interface. At step S228, optional medication module 66 accesses drug database 76, using the symptom as a query. Drug database 76 will return a suggested medication and a suggested dosage. Optional medication module 66 may also give further instructions. It is envisioned that drug database 76 may store information corresponding to medications that are contained in dispensing device 20 and selected medications that the physician, the pharmacy or the manufacturer recommend be stored in drug database 76. Thus, there may be symptoms for which no information is stored in drug database 76. If the drug database does not contain any suggestions, optional medication module 66 may contact at least one of the health care provider server 80, the pharmacy server 82, and one or more pharmaceutical company servers 84 via communication module 72. It is further envisioned, that the query may be directed to a back-end server that communicates with the health care provider server 80, the pharmacy server 82, and one or more pharmaceutical company servers 84. The suggestion and corresponding additional information may be displayed on the screen, via the user interface as shown, for example, in FIG. 12C. It is appreciated that other methods for suggesting an optional medication may be implemented by optional medicine module 66.

The patient may instruct the dispensing device 20 to dispense an optional medication via the user interface. The patient may selected a suggested medication, as described above, or may select a medication without using the suggestion mode. Optional medication module 66 may then transmit the request to the dispensing module 62.

Optional medication module 66 may also provide educational information relating to the selected medication via the user interface. Upon receiving a request for a medication, optional medication module 66 may communicate the requested medication, either by name or by a corresponding identification number, to education module 70. Education module 70 will return educational information relating to the selected drug. Optional medication module 66 may display the education information via the user interface.

Optional medication module 66 may also communicate with ADE module 64. Prior to making a suggestion to the patient, optional medication module 66 may transmit the medication suggestion to the ADE module 64. ADE module may look up the schedule for the scheduled medications from medical regimen table 78 and determine weather the suggestion may cause a dangerous condition.

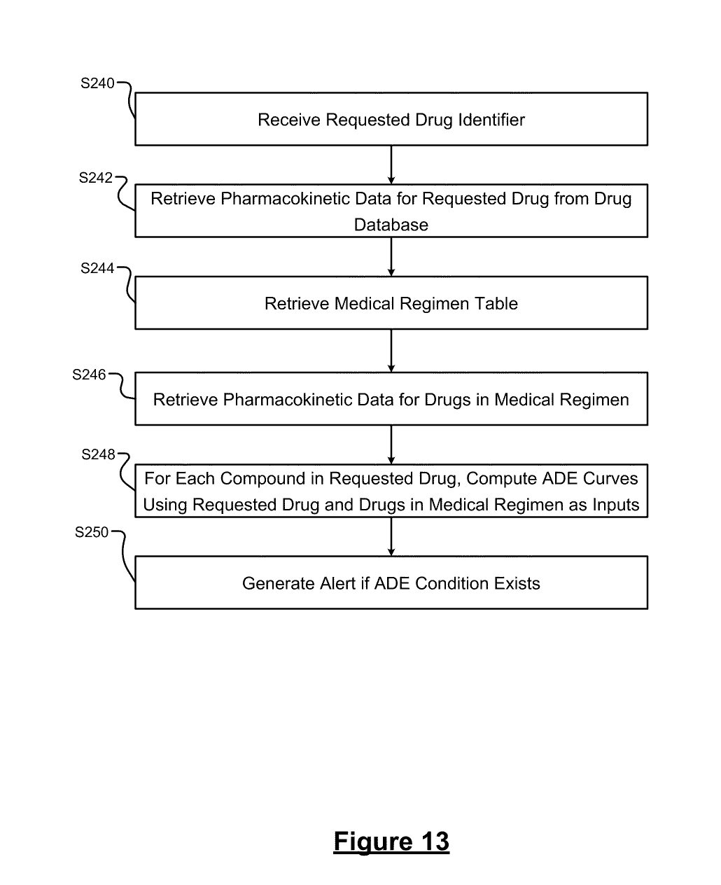

Adverse drug effect (ADE) module 64 receives a requested drug identifier and calculates the risk associated with administering the requested drug in combination with recently administered medications and in view of future scheduled doses of scheduled medications. More specifically, ADE module 64 may determine whether levels of certain compounds found in the requested drug will exceed a threshold if the requested drug is administered given the recently administered and scheduled medications. ADE module 64 may be called by a number of modules, including scheduled medication module 68, optional medication module 66, dispensing module 62, and prescription management module 75. ADE calculation results may be used to warn a patient not to take a particular medicine at a particular time or to generate a schedule so that medicines that would ordinarily cause adverse effects may be taken without substantially increasing levels of a particular compound. ADE module 64 may calculate compound levels as a function of time. Thus, this type of data may be easily transferred to a graph, which may be displayed by ADE module 64 to the patient via the user interface. FIG. 13A provides an exemplary graph depicting drug levels in a patient's body over the course of time.

ADE calculations are based on the pharmacokinetic properties of one or more drugs. The pharmacokinetic properties of each drug are stored as pharmacokinetic data in drug database 76. Typical pharmacokinetic properties may include the absorption properties of the drug, the distribution properties of the drug, the metabolism properties of the drug, and the elimination properties of the drug. Absorption is the process of a substance entering the body. Distribution is the dispersion of substances throughout the fluids and tissues of the body. Metabolism is the irreversible transformation of parent compounds into daughter metabolites. Excretion is the elimination of the substance from the body. It is envisioned that other types of pharmacokinetic properties may be stored in the pharmacokinetic data, including linearity and liberation.

ADE calculations may be calculated for each type of pharmacokinetic properties. The pharmacokinetic properties may be represented as a function of time. Thus, for each compound in a pharmaceutical drug, a time function may represent the body's reacts to the compound after a certain amount of time following administration of the dose.

The following demonstrates a simple mono-dimensional example of absorption. It is noted that similar calculations may be performed for the other pharmacokinetic properties. In this example, a single drug is analyzed. The pharmacokinetic data may be presented in the form: Med₁(t)={f₁ₐ(t), g_{1b}(t), h_{1c}(t)}, wherein Medication 1 has three active components: a, b, c, and absorption over time of component a is represented by the function f₁ₐ(t); for b by g_{1b}(t); and for c by h_{1c}(t).

In a second example, a three drug regimen is analyzed. The drug regimen is comprised of Medicine 1, Medicine 2, and Medicine 3. The pharmacokinetic data may take the following form:Med₁(t)={f₁ₐ(t), g_{1b}(t), h_{1c}(t)}, Med₂(t)={g_{2b}(t), i_{2d}(t)}, Med₃(t)={f₃ₐ(t), g_{3b}(t)}. Based on the schedule of the medical regimen, the regimen may be described by a sequence of drugs ingested at a given time t such that: Regimen=(Med₁(8:00), Med₂(10:00), Med₁(12:00), Med₃(12:00)). In reality, however, the patient takes the regimen at the following times: Effective_Regimen=(Med₁(7:50),Med₂(11:00), Med₁(12:07), Med₃(12:07)).

In the foregoing example, calculation of the ADE utilizes these times to make an updated calculation of ADE for each of the components as follows:

Component a=f₁ₐ(7:50)·f₁ₐ(12:07)·f₃ₐ(12:07)

Component b=g_{1b}(7:50)·g_{2b}(11:00)·g_{1b}(12:07)·g_{3b}(12:07)

Component c=h_{1c}(7:50)·h_{1c}(12:07)

Component d=i_{2d}(11:00)

Where the · operator means the composition of these functions. In a very simple embodiment · is the addition operation. More complex calculations may consider the interdependencies of certain pharmacokinetic properties such as absorption and dispersion, rates of change, and physical characteristics of the patient. An ADE module 64 running on a more powerful processor or capable of communicating rapidly with a back-end server may also be configured to receive parameters specific to the patient when calculating levels of compounds in the body. Additional parameters include the patient's weight, height, age, heart rate, blood pressure, and glucose levels. For example, ADE module 64 could calculate the excretion of a compound A taken at time t by a patient weighing W pounds. It is envisioned that ADE module 64 may implement any known or later developed algorithms for computing an ADE calculation.

FIG. 13 depicts an exemplary method for calculating an ADE given a requested drug. At step S240, ADE module 64 receives a requested drug. At step S242, ADE module 64 retrieves the pharmacokinetic data for the requested drug from drug database 76, or from healthcare provider server 80, pharmacy server 82, or pharmaceutical company server 84. Alternatively this information may be retrieved from a back-end server operated by the manufacturer of the dispensing device 20 or a third party. At step S244, ADE module 64 retrieves the medical regimen table 78 and determines which drugs were recently administered to the patient and which drugs are scheduled to be administered in the near future. At step S246, ADE module 64 retrieves the pharmacokinetic properties of the drugs identified in step S244.

Once the pharmacokinetic data for all relevant drugs has been retrieved, ADE module 64 may make the appropriate ADE calculations at step S246. ADE module 64 may compute an ADE calculation for each compound found in the requested drug. The ADE calculation, of course, still computes the ADE calculation using recently administered medications and/or scheduled medications, but generally only the active compounds in the requested medication are relevant to the computations. ADE module 64 may, however, compute an ADE calculation for compounds found in any of the relevant drugs.

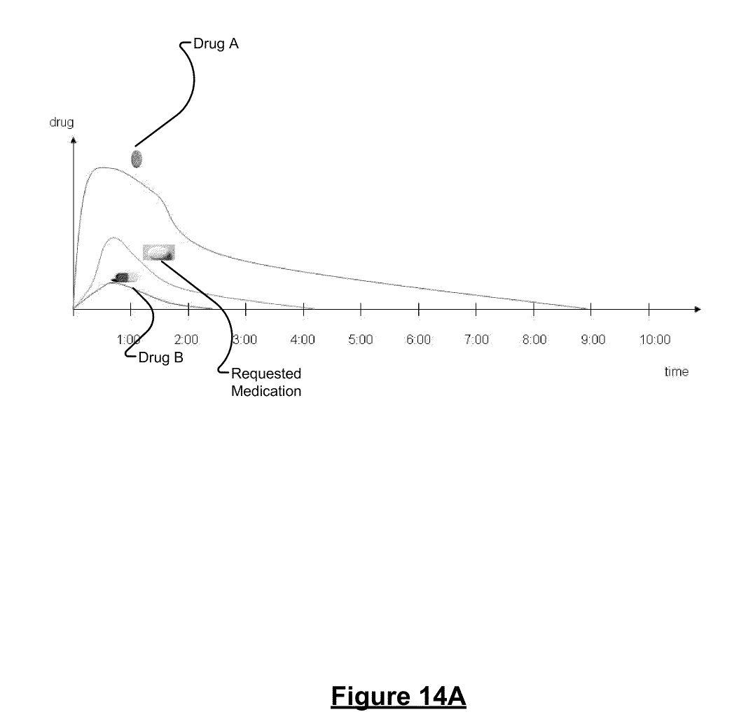

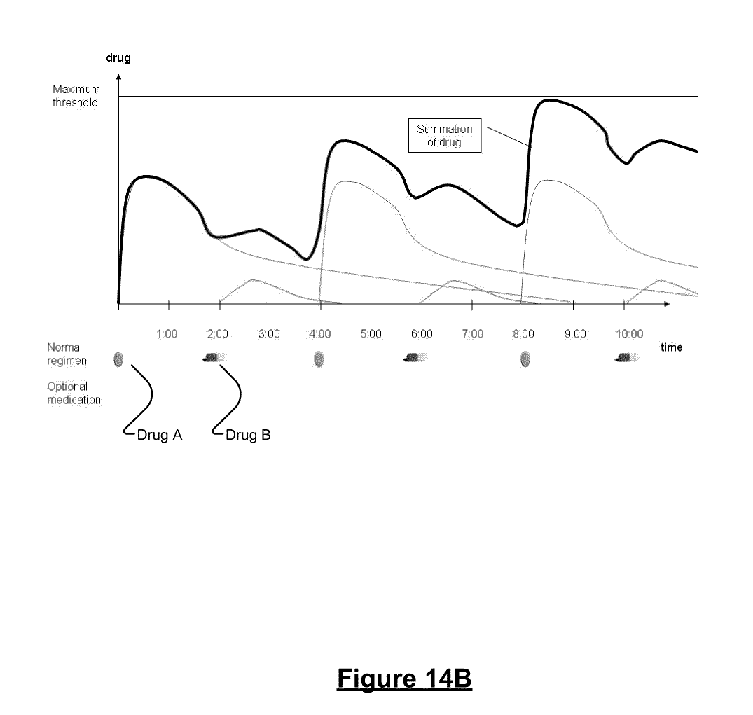

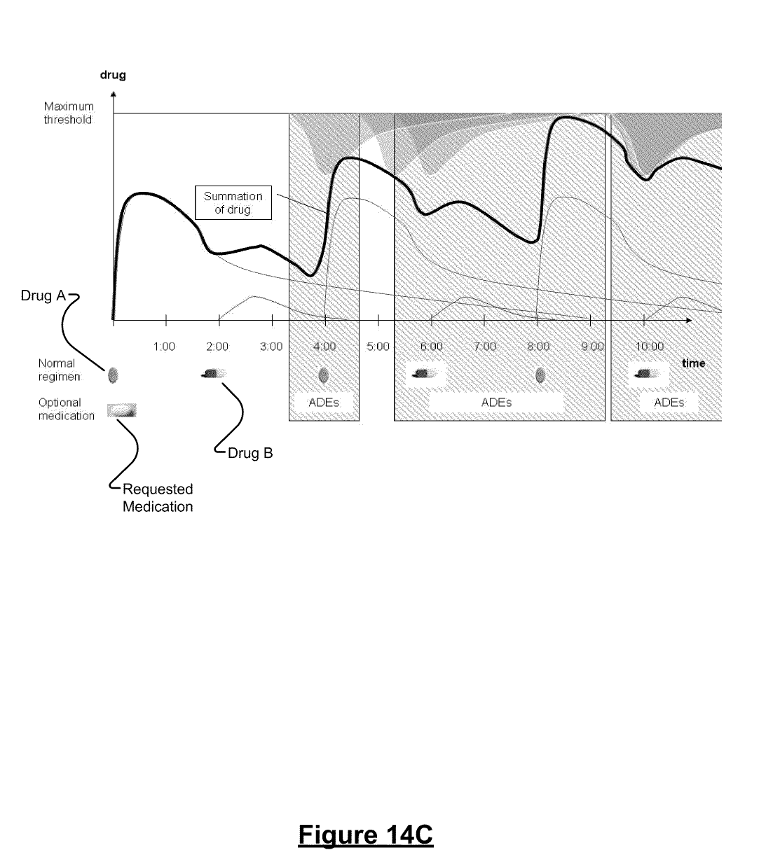

ADE module 64 may perform calculations for all relevant pharmacokinetic properties, e.g. absorption, excretion, metabolism, and distribution. In the simplest embodiment, ADE module 64 determines the cumulative effect of taking the requested medication at a specific time by adding the pharmacokinetic properties of each compound. FIG. 14B depicts an example of two drugs taken on a regular schedule. As can be seen, drug B is processed much more quickly than drug A and contains a lesser amount of the analyzed compound. As can also be seen, drug A is not fully processed by the body when it is taken again at 4:00. In fact, residual amounts of the compound are not processed when a third dose of drug A is taken at 8:00. As can be seen, the level of the compound approaches the maximum threshold. This example does not factor in the administration of the requested drug. Rather, FIG. 14B illustrates the levels of the compound when the patient adheres to the regular schedule.

ADE module 64 may be used to determine if administration of an optional medication would result in an adverse effect. When such a request is made, ADE module 64 assumes that the patient will take the optional medication at the time the medication is requested. ADE module 64 may then add the pharmacokinetic data corresponding to the optional medication to the pharmacokinetic data corresponding to the regularly scheduled medication to determine if an adverse effect is possible. If ADE module 64 determines that an adverse effect is possible, i.e. if any of the compound levels corresponding to the administration of the combination of the drugs exceeds the predetermined threshold, ADE module 64 will send a notification to the user via the user interface and to the treating physician via the communication module 72.

FIG. 14C depicts a scenario when an optional drug is requested from dispensing device 20. As can be seen, the regularly scheduled medications have the same properties. In this scenario, ADE module 64 may determine what intervals are safe to take the optional medicine. ADE module 64 may accomplish this in various ways. The simplest way is to perform a brute force method, where ADE module 64 calculates the curve as if the optional medicine was taken at various times along the timeline. ADE module 64 may calculate the curve corresponding to the requested drug and slide the curve along the timeline to determine times corresponding to administering the drug that could result in ADEs. Another way to calculate the safe periods for administration of a drug is to subtract the compilation of the compound levels of the regularly scheduled drugs from the threshold and determine at which periods the compilation of the regularly scheduled medications could be taken, i.e. times corresponding to administration of the drug where the compound levels of the optional medicine would probably not reach the resulting curve. For liability purposes, ADE module 64 may lower the predefined threshold to provide for a margin of error in the pharmacokinetic data.

Depending on the circumstances under which ADE module 64 was called, ADE module 64 may report its results in various forms. ADE module 64 may generate a warning to the patient via the user interface. A warning to the patient may be appropriate when the patient requests the dispensing of an optional medication that would result in the levels of a particular compound exceeding the predetermined threshold corresponding to an increased risk of an ADE. ADE module 64 may send a notification to the treating physician, via the communication module 72, in a similar situation or if the treating physician issues a prescription that cannot be taken safely with the regularly scheduled medications. ADE module 64 may generate a graph for display via the user interface when the patient requests possible times for safe administration of an optional medication. The graph, similar to the graph in FIG. 13C, may display to the user safe periods for administering the optional medication.

Education module 70 provides educational information to the user. Educational information may include instructions to follow if a scheduled dosage was missed, what common side effects are for a medication, and information on the medication and its mechanisms. Education module 70 communicates with drug database 76 to retrieve information corresponding to drugs contained in the dispensing device 20. As discussed, this information may be uploaded into the database when the dispensing device 20 is cradled and the prescription is being loaded, or this information may be received over a communications network via the communications module 70, independent of the actual filling of the prescription medication.

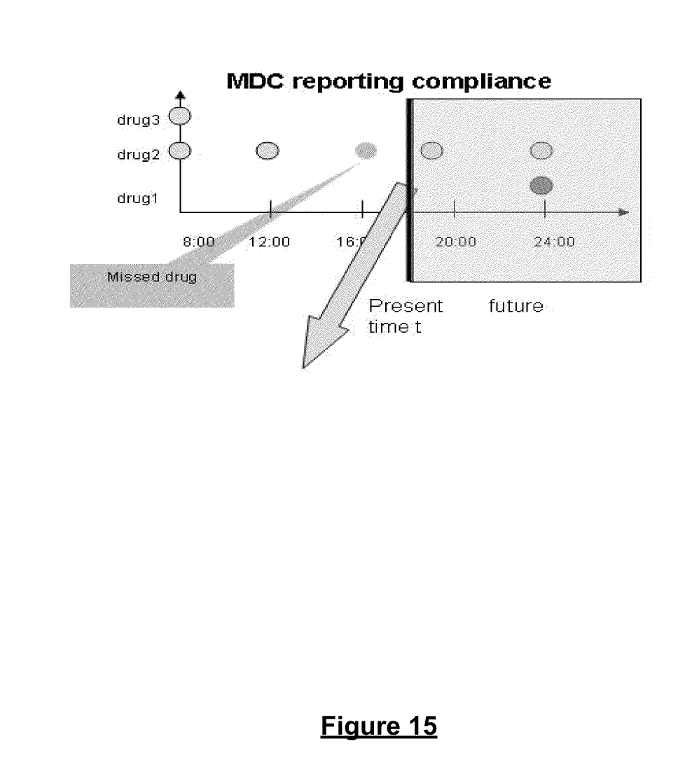

Education module 70 may also communicate with the medical regimen table 78. As a result, education module may easily determine the status of the patients prescription. FIG. 15 shows a representation of the status of a patient's prescription as may be determined from the medical regimen table 78. As can be seen, instances where a patient did not take the scheduled medication may be readily determined. For each type of medication, there exists a set of instructions that should be followed when a medication is missed. These instructions may be stored in drug database 76. Furthermore, these instructions may be coded into a simple algorithm, such that for each medication, the user is prompted by certain messages depending on the medication and how much time has lapsed since the previously scheduled dosage. These algorithms may be decision trees that guide patients in the actions that should be performed at specific times. The following provides one exemplary algorithm for an exemplary medication, Medᵢ:

```
If Medᵢ(t, t+15’) /* normal, no error message */
Else If Medᵢ(t+15, t+30’) /* send reminder message */
    (“e.g. please take time Medᵢ it is overdue”)
Else If Medᵢ(t+30’, t+2h) /* send to-do message */
    (“e.g. you are late for your Medᵢ(t), please take it ASAP) , or
    (“e.g. you are late for your Medᵢ(t). Please skip it and take two doses
    at time tₙ)
Else if Medᵢ(t+2h’, t+4h) /* send to-do message and education */
    (“e.g. you missed your Medᵢ(t). Skip it. Your next medication is
    Medⱼ (tᵢ)), AND Display the education file in Table 1
```

It is envisioned that other types of algorithms may be used to generate educational information for the patient.

Education module 70 may also communicate educational information on side effects of a medication or what medication is causing a side-effect. As mentioned, education module 70 may determine the status a patient's prescription. Accordingly, education module 70 may determine what medications the patient has taken and at what times. Thus, if a patient is suffering from a side-effect and is unsure what medication is causing the side effect, the patient can enter the symptom or side-effect and the education module 70 will determine the cause of the side-effect. Based on what medications the patient has taken, the times the medications were taken, and the reported side effect, education module 70 loops through all the medications contained in drug database 76 and then loops through the side effects to determine if any of the side effects correlate with recently administered medications. Education module 70 may perform the following algorithm to reach this result:

```
For all Medₓ(t)
  If (t_{d}is different from N/A)
    While Sideeffects is different from ObservedSyptom { } /* loop on
all side effects */
    If ((ObservedSymptom is equal to symptomᵢ Medᵢ(t)) AND
    (t_{d}− current time < Threshold_{Time})) /* recent observation */
        {
        occurrenceᵢ++
        Display message:
            “ObservedSymptom is a repertoriated side effect of Medᵢ(t),
            you reported a similar side effect occurrenceᵢ times before,
            followupᵢ”
            /* Printed: Ulcer is a repertoriated side effect of Aspirin
            you reported a similar side effect 2 times before,
            call your Physican*/
        correlationᵢ+=((occurrenceᵢ− card(Dispensedᵢ))/card(Scheduleᵢ))²
        /* correlation can be updated in this loop*/
        }
```

Where t_{d} represents the time Medᵢ(t) has been dispensed, N/A represents that Medᵢ(t) has not yet been dispensed, symptomᵢ describes a symptom linked to Medᵢ(t), e.g. ‘headache’; occurrenceᵢ, represents the number of occurrences reported by the user; followupᵢ describes follow-up actions, e.g. ‘call immediately your physician’; and correlationᵢ is the calculation of the correlation between symptomᵢ and the medication. It is envisioned that other algorithms for determining a side-effect may be utilized by education module 70.

Education module 70 may also calculate a patient's overall compliance to a treatment regimen. Compliance may be calculated as a quadratic error compared to the optimum adherence to the regimen. An exemplary compliance algorithm is presented as follows:

Compliance = 0;
For all Medₓ(t)
If (t_{d}is different from N/A)

Compliance += (Schedule − t_{d})²
Else
Compliance += MissedMeds.

When a patient's compliance or, better stated, lack of compliance, exceeds a predetermined threshold, education module 70 may retrieve educational information from drug database 76, or from external sources such as the primary healthcare provider server 80, the pharmacy server 82 or one or more pharmaceutical company servers 84. The educational information may be displayed to the patient, via the user interface.

Education module 70 may also receive requests for educational information from the patient via the user interface. A patient may enter a select a question pertaining to a medication and education module 70 may retrieve the answer from the drug database 76. For example, the patient, after missing a scheduled dose, may inquire what the best course of action is. Education module 70 may retrieve educational information corresponding to the selected medication from drug database 76 and return an answer based on the question and the factual circumstances surrounding the question. For example, education module 70 may determine that the patient missed his or her dose by over an hour. Based on the educational information provided by the pharmacy or pharmaceutical company, education module 70 may suggest taking a double dose at the next scheduled administration of the drug.

Communication module 70 transmits and receives data to and from the dispensing device 20. Communication module may send communications, via the transceiver 24, to the health care provider server 80, the pharmacy server 82, and one or more pharmaceutical company servers 84. In an alternative embodiment, communication module 72 may communicate with a back-end server, which in turn directs the communications to the relevant servers 80-84.

The foregoing description of the various embodiments of an electronic medicine dispensing device 20 and the corresponding modules allow for a novel method of closing the supply chain management loop. As may be appreciated from the present disclosure, there are three main parties involved in the supply chain, i.e. the patient, the physician, and the pharmacy/pharmaceutical company. The patient is prescribed a medication by the physician, who may be employed at a hospital or other type of healthcare facility, such as a private office. The physician typically transmits the prescription to a pharmacy. The pharmacy fills the prescription for the patient.

In the absence of Applicant's invention, the supply-chain is an open loop. The treating physician writes the prescription and sends it to the pharmacy. The pharmacy receives the prescription and provides the medication to the patient. The patient receives the medication. Thus, there exists no feasible way for the physician to ensure that the patient has adhered to the prescribed therapy. The dispensing device 20 described above, however, provides a feasible means to provide a feedback loop to the treating physician and the pharmacy.

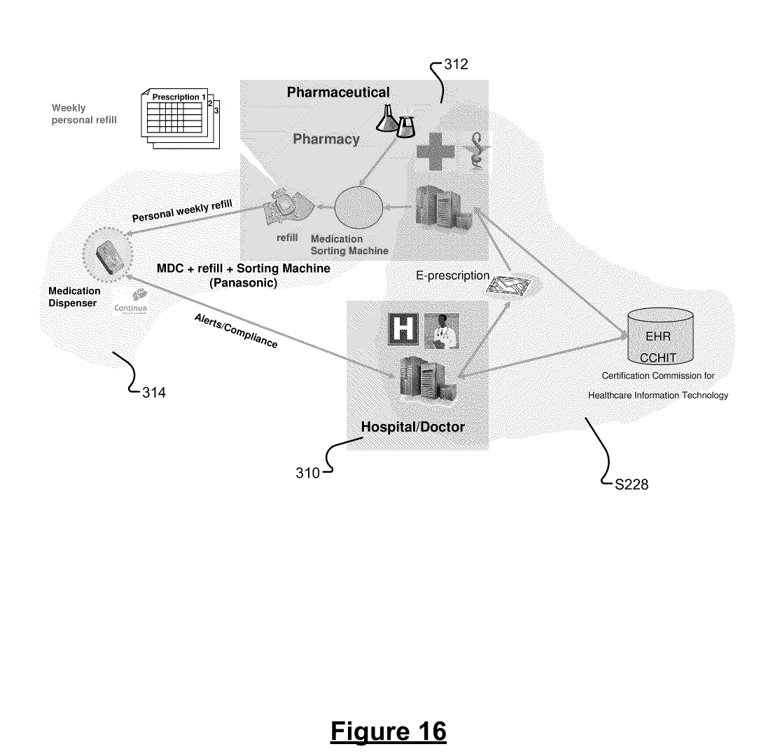

FIG. 16 depicts an exemplary supply chain enabled by use of the electronic medicine dispensing device 20. The treating physician, employed by a health care provider, writes a prescription for the patient 314. The prescription is sent to the pharmacy 312. At the pharmacy 312, the prescription is filled into a cartridge or blister pack. It is envisioned that the pharmacy may prepare a cartridge or blister pack containing all the patient's required medications for the week. The cartridge or blister pack may also include a memory chip that stores prescription information, educational information, and pharmacokinetic data for each medication contained in the cartridge or blister pack. The patient 314 may either pick up the medication from the pharmacy 312 or receive the medication in the mail. It is envisioned that the pharmacy 312 may send presorted and packaged cartridges or blister packs to the patient 314 in the form of a weekly allotment of medication.

Upon receiving the medication, the patient 314 will refill the dispensing device 20. As described, information relating to prescription may be uploaded into the medical regimen table 78 of the dispensing device 20 when the device is filled by the patient. Dispensing device 20 may send an alert to the physician that the patient has received the medication and has filled the medication into the dispensing device 20. Such communications do not need to be transmitted directly to the doctor, but may be transmitted from the communication module 72 to the health care provider server 80. By allowing communication from the dispensing device 20 to the treating physician, the supply chain loop may now be thought of as a closed loop. It is envisioned that additional information, such as patient's compliance to the treatment regimen, ADEs, educational information requests, or combinations of medications, may be reported to the treating physician, as well. By closing the loop, physicians may be able to access the health care provider server 80 to determine if a patient is adhering to the treatment regimen.

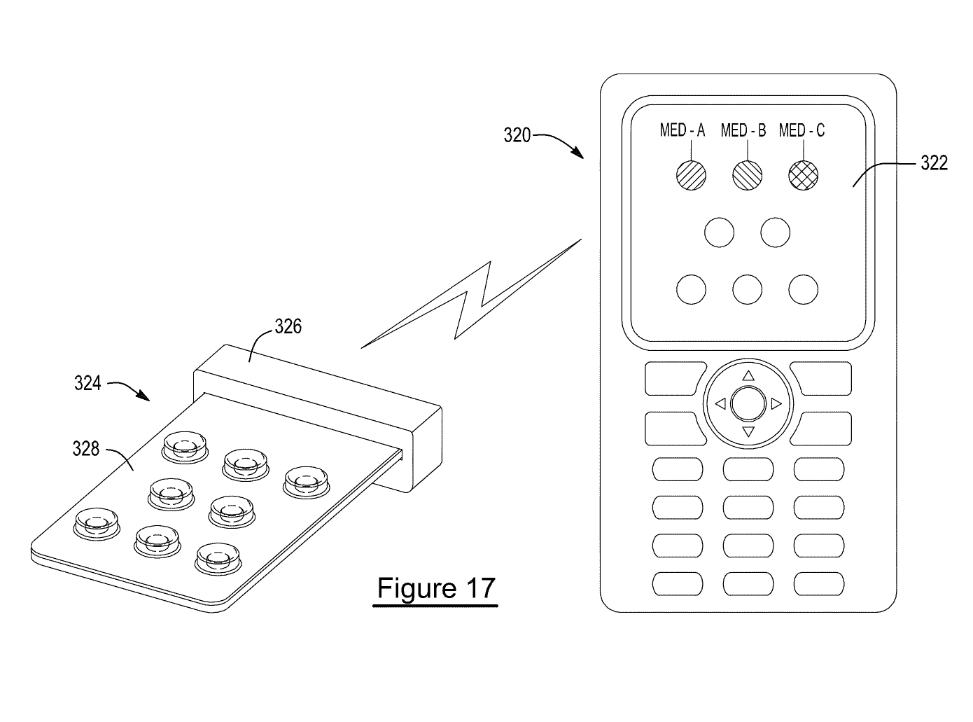

FIG. 17 depicts an alternative embodiment of the medication dispensing device. It is envisioned that the foregoing framework may be applied to a simplified drug dispenser 324 in communication with a handheld device 320 such as a cell phone, MP3 player, PDA, or other handheld device capable of communicating audio and/or video and/or images to a patient. In the alternative embodiment, the patient may receive blister packs 328 or other containers for holding medication. The blister packs or other containers would come in a cartridge that contains the prescription and prescription information. The blister pack 328 is received by a controlling device 326. The controlling device 326 is in communication with exemplary handheld device 320. Either the controlling device 326 or the handheld device 320 may receive the prescription and prescription information. Exemplary handheld device 320, as it likely will have more processing power than controlling device 326, may be where the modules described above reside. It is envisioned, however, that the modules could reside on the controlling device 326 in an alternative embodiment. Moreover, exemplary handheld device 320 may communicate with the back-end server, the health care provider server, the pharmacy server or the one or more pharmaceutical company servers, as communication will likely already be enabled on the handheld device 320. This is not to say that the controlling device 326 cannot have communication enabled as well, however. Exemplary handheld device 320 may communicate messages to the patient via user interface 322.

In this alternative embodiment, in addition to or in place of communications to the patient on the user interface, the patient may also receive instruction from the blister pack 328 itself. The blister pack 328 may have thermochromic ink that is deposited onto the inward facing side of the sealing layer of the blister pack 328. Thermochromic ink is sensitive to temperature change. For example, when subject to a temperature change of about 5 degrees F, a thermochromic ink may change from a clear state to a specific color, such as blue, or conversely from a specific color to a clear state. It is envisioned that photochromic ink and other types of color changing inks may be used in place of thermochromic ink. Because the blister pack 328 can be implemented using paper and ink, it can be manufactured and disposed of in an ecologically friendly manner. The controlling device 326 may be configured to manipulate the thermochromic ink so that messages or instructions may be displayed to the user on the blister pack. For example, if a patient is supposed to take a particular pill at a specific time, the thermochromic ink around the particular pill may change color at the specific time.

As used herein, the term module may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality. It is should be understood that when describing a software or firmware program, the term module may refer to machine readable instructions residing on an electronic memory.

Furthermore, the term handheld device may refer to the medication dispensing device 20 described above, as well as a cell phone, a PDA, an MP3 player, a portable video game player, or any electronic device now known or later developed that is able to provide audio and/or image and/or video to the patient.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. An patient centric electronic medication dispensing device comprising:
a handheld device;
a prescription download module that receives a prescription of a patient and prescription information from a pharmacy, wherein the prescription includes a medication of the patient and instructions for administering the medication; and
a prescription management module that that generates a treatment regimen for the patient based on the prescription and the prescription information, and that sends a notification to a server associated with a physician treating the patient when the patient deviates from the treatment regimen based on data corresponding to administration of the medication by the patient and the treatment regimen.

2. The patient centric electronic medication dispensing device of claim 1 wherein the prescription management module communicates a notification to the patient when the patient deviates from the treatment regimen.

3. The patient centric electronic medication dispensing device of claim 1 wherein the prescription management module updates the treatment regimen when the patient deviates from the treatment regimen.

4. The patient centric electronic medication dispensing device of claim 1 further comprising an education module that retrieves educational information corresponding to the medication from a drug database and communicates said educational information to the patient.

5. The patient centric electronic medication dispensing device of claim 4 wherein the educational information includes instructions for the patient to follow when the patient deviates from the regimen.

6. The patient centric electronic medication dispensing device of claim 5 wherein the prescription management module receives instructions for the patient to follow when the patient deviates from the regimen from the education module when the patient deviates from the treatment regimen and that communicates said instructions to the patient.

7. The patient centric electronic medication dispensing device of claim 1 further comprising an adverse drug effect module that calculates a cumulative level of an active compound found in a combination of a plurality of medicines and that generates an alert when the cumulative level exceeds a predetermined threshold.

8. The patient centric electronic medication dispensing device of claim 7 wherein the calculated cumulative level of an active compound is a function of time.

9. The patient centric electronic medication dispensing device of claim 8 wherein the adverse drug effect module identifies time periods when the patient can administer a portion of the combination of the plurality of medicines without the cumulative levels of the active compound exceeding the predetermined threshold.

10. The patient centric electronic medication dispensing device of claim 7 wherein the adverse drug effect module communicates the alert to the patient.

11. The patient centric electronic medication dispensing device of claim 4 wherein the educational information includes known side-effects associated with medications contained in the dispensing device.

12. The patient centric electronic medication dispensing device of claim 11 wherein the education module is operable to receive a sensed side-effect from the patient and to determine a cause of the side-effect based on the treatment regimen and the sensed side-effect.

13. A patient centric medication dispensing device comprising:
a handheld device;
a datastore storing a treatment regimen for a patient to administer medication, wherein the treatment regimen includes a schedule for administering the regularly scheduled medication and times when the medication was previously dispensed;
a dispensing module that receives a request from a patient for a requested medication to be dispensed by the dispensing device;
an adverse drug effect module that calculates a cumulative level of at least one active compound found in the requested medication, wherein the cumulative level represents an amount of the at least one active compound in the patients body that would result if the patient administered the requested medication, previously dispensed medication and the regularly scheduled medication, and that generates an alert when the cumulative level exceeds a predetermined threshold.

14. The patient centric medication dispensing device of claim 13 wherein the adverse drug effect module calculates the cumulative level of the at least one active compound based on pharmacokinetic properties of the requested medication, pharmacokinetic properties of the previously dispensed medication and pharmacokinetic properties of the regularly scheduled medication.

15. The patient centric medication dispensing device of claim 13 wherein the adverse drug effect module determines at least one time period when the patient may take the requested medication based on the schedule for the patient to administer regularly scheduled medication and the times when medication was previously dispensed.

16. The patient centric medication dispensing device of claim 13 wherein the cumulative level of the at least one active compound found in the requested medicine is a function of time.

17. The patient centric medication dispensing device of claim 14 wherein the pharmacokinetic properties of the requested medication, the pharmacokinetic properties of the previously dispensed medication, and the pharmacokinetic properties of the regularly scheduled medication include properties relating to at least one of absorption, excretion, distribution, and metabolism of the at least one compound found in the requested medication.

18. The patient centric medication dispensing device of claim 14 wherein the cumulative level of the at least one active compound is further based on physical characteristics of the patient.

19. The patient centric medication dispensing device of claim 13 wherein the adverse drug effect module is further operable to transmit the alert to a physician of the patient.

20. A patient centric medication dispensing device comprising:
a handheld device;
a datastore storing a treatment regimen for a patient to administer medication of the patient;
a drug database storing educational information corresponding to the medication of the patient;
a dispensing module that dispenses medication to the patient based on a request of the patient and the treatment regimen for a patient to administer the medication;
a prescription management module that monitors the patient's compliance to the treatment regimen and that notifies the patient if the patient deviates from the treatment regimen; and
an education module that retrieves the educational information from the drug database based on the patient's deviation from the treatment regimen and generates a message for the patient based on the educational information and an amount of deviation from the treatment regimen, wherein the educational information includes instruction for the patient to follow when the patient deviates from the treatment regimen.

21. The patient centric medication dispensing device of claim 20 wherein the instruction for the patient to follow when the patient deviates from the treatment regimen is based on a decision tree, wherein the decision tree makes decision based on the medication and the amount the patient deviated from the treatment regimen.

22. The patient centric medication dispensing device of claim 20 wherein the educational information includes known side-effects associated with medications contained in the dispensing device.

23. The patient centric medication dispensing device of claim 20 wherein the education module is operable to receive a sensed side-effect from the patient and to determine a cause of the side-effect based on the treatment regimen and the sensed side-effect.

24. The patient centric medication dispensing device of claim 20 wherein the treatment regimen is further defined as a schedule.

25. A patient centric medication dispensing device comprising:
a handheld device;
a prescription download module that receives a prescription of a patient and prescription information from a pharmacy, wherein the prescription includes a regularly scheduled medication and instructions for administering the regularly scheduled medication, and wherein the prescription information includes pharmacokinetic properties of the regularly scheduled medication;
a prescription management module that that generates a schedule for administering the regularly scheduled medication based on the prescription and the prescription information, and that sends a notification to a server associated with the physician when the patient deviates from the schedule, wherein the schedule is stored in a data store;
an optional medication module that receives a request from a patient for an optional medication to be dispensed by the dispensing device;
an adverse drug effect module that calculates a cumulative level of at least one active compound found in the requested optional medication, and that generates an alert when the cumulative level exceeds a predetermined threshold, wherein the cumulative level represents an amount of the at least one active compound in the patients body that would result if the patient administered the optional medication and the regularly scheduled medication, and wherein the cumulative level of the at least one active compound is based on the pharmacokinetic properties of the regularly scheduled medication and pharmacokinetic properties of the requested optional medication;
a drug database storing educational information corresponding to the medication of the patient; and
an education module that retrieves the educational information from the drug database when the patient deviates from the schedule and communicates said educational information to the patient, wherein the educational information includes instruction for the patient to follow when the patient deviates from the schedule.
